(19) United States
(12) Patent Application Publication
(10) Pub. No.: US 2011/0094448 A1
(43) Pub. Date: Apr. 28, 2011

(54) PORTABLE ANIMAL FEEDING DEVICE

(76) Inventor: John W. MOUNTS, Bellville, TX (US)

(21) Appl. No.: 12/607,182

(22) Filed: Oct. 28, 2009

(51) Int. Cl. A01K 5/00

(52) U.S. Cl. 119/60

(57) ABSTRACT

Four or more concentric rings are vertically separated from each other by placement along the vertical axis of four support members. The circular construction accommodates hay bales for feeding animals. The openings between the concentric circles are defined by their placement along the vertical axis of the support members. The structure may be comprised of one or more sections that may disassembled for relocation. Alternatively, the system may be of a unitary construction.

### BACKGROUND OF THE INVENTION

The invention relates generally to animal feeders and, in particular, to a portable feeder of light weight construction and low cost.

Bales of hay, in particular, Round bales of hay are used to feed livestock during the months in which pasture grasses are in a dormant stage. Round bales vary in sizes with the largest typically being five (5) feet by six (6) feet. When feeding, livestock have a tendency to pull hay from the round bale which is not consumed and falls to the ground. Once this hay is on the ground, livestock then trample the hay into the earth making it inedible, thus wasting a significant portion of the consumable hay.

In an effort to eliminate such waste, hay rings were developed. Traditional hay rings are comprised of a set of rings that encompasses the outer circumference of a single round bale. These rings are proportionately spaced and supported by a number of vertical posts. The hay ring allows livestock to pass their head and neck through the rings and consume the round bale but prohibit them from crawling into the hay ring. The hay ring configuration allows the livestock to consume the hay without dropping hay outside the ring where it would be trampled and wasted. As the round bale is consumed, livestock have to reach further into the hay ring, which means livestock are putting undue stresses on conventional hay rings. Livestock may also push and slide the hay ring to obtain the last portions of the round bale, straining the structural integrity, bending and even breaking the hay ring. Improper round bale loading, tractor and loader impacts are more examples of damage that can occur to traditional hay rings which make them less efficient or not usable.

Typically, hay rings are constructed from carbon steel, which is highly susceptible to the corrosive elements. Such corrosive elements are not only generated by the weather but also the livestock due to the manure and urine immediately around the hay rings. Corrosion can cause a hay rings to fail, and corroded or broken hay rings increase the likelihood of livestock becoming injured on sharp or jagged pieces of the hay ring. Damaged, corroded, and broken hay rings of traditional construction must be replaced on a routine basis.

Additionally, farmers have long desired a mobile, light-weight and inexpensive animal feeder and, particularly, an inexpensive cattle feeder which can be turned on its side and easily rolled or disassembled to that portion of the farm where it is most needed. Previous animal feeders have not proved satisfactory and have not received significant commercial acceptance.

An example of prior art feeders is illustrated in U.S. Pat. No. 3,020,881. Such a cattle feeder has only six access openings, thereby necessitating an extended feed time for a large herd of animals. Owing to the vertical nature of the access opening to the feeder, it is necessary to provide telescoping, vertical posts to adjust the size of the feeder to admit both large cattle and calves, for example. Such adjustable access sections render the feeder more complicated and expensive.

What is needed is a animal feeder that is lightweight, less reactive to the elements and weather, durable and that will accommodate bother circular hay bales and loose hay, and that may be easily transported from one area of the farm to another.

### SUMMARY OF THE INVENTION

It is, therefore, an object of the present invention to provide an improved portable animal feeder capable of feeding a variety of animals without adjustment of its feeding stations and adapted to feed, simultaneously, a relatively large number of animals.

It is another object of the present invention to provide an improved animal feeder capable of being loaded from the top, bottom, or side.

It is still another object of the present invention to provide an improved animal feeder requiring minimum assembly, maintenance, and adjustment.

The above and other objects are met in the present portable animal feeding device having top opening and bottom opening, at least four vertically spaced concentric circles of substantially equal diameter, and at least four support members parallel to each other and intersecting each concentric circle at a predetermined location along the support members vertical axis.

### BRIEF DESCRIPTION OF THE DRAWINGS

The above and other objects, features, and advantages of the invention will be apparent upon consideration of the following detailed description, taken in conjunction with the accompanying drawings, in which like reference characters refer to like parts throughout.

FIG. 1 is a perspective view of the portable animal feeding device of the present invention.

### DETAILED DESCRIPTION

The production of hay in large round roll-type bales involves feeding of the hay to farm animals in feed lots. Typically, the bale will be moved by a tractor to the feeding station. The usual practice is to allow the animals to gather round the bale and eat from it without restriction. This practice results in fifty percent or more waste by the hay being trampled into the ground.

The portable animal feeding device of the present invention provides for the restriction of animals via head openings in the circular structure from trampling hay placed within the device. As a bale or the loose hay placed within the device is finished, the structure may be easily disassembled or rolled to a new feeding location and refilled.

The portable feeding device may be filled in several different ways. For example, the feeding device may be tipped over onto a bale of hay. The feeding device may be loaded with a bale or loose have from the top. The feeding device may also be filled from the sides of the device (in-between the concentric circles).

The portable feeding device of the present invention is constructed from light durable materials such a polyvinylchloride (PVC) or any other suitable material such that it is strong enough to allow the feeding animals to move the device so that the feeding can get to the hay after it has been substantially consumed. Additionally, since the device is constructed of lightweight materials, it will not become permanently frozen to the ground during winter months.

In some embodiments, the feeding device of the present invention may be constructed of cylindrical polyethylene. Polyethylene has extreme strength and flexibility characteristics. The characteristics of the polyethylene allow the animal feeder of the present invention to resume its original shape after impacts by feeding animals, tractors, and loaders.

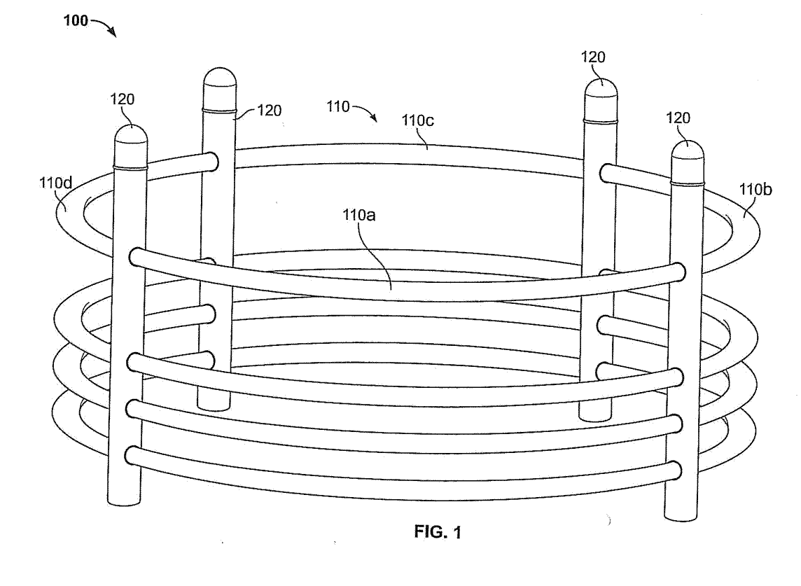

As shown in FIG. 1, portable animal feeding device 100 of the present invention includes at least four rings 110. Rings 110 are constructed of tubular material, as mentioned above, and interconnected and spaced apart by tubular vertical supports 120. The head openings for feeding animals are formed by vertical support members 120 and the two upper rings 110.

As previously mentioned device 100 may be unitary in its construction or constructed from four sections. As shown in FIG. 1, each of the four sections is constructed with two vertical supports 120 and quarter rings 110a, 110b, 110c, and 110d.

A preferred structure in an embodiment of the present invention may include four (4), three (3) inch diameter, polyethylene tubular support member each being approximately forty-six (46) inches in height. The internal diameter of the present invention may be approximately 7.5 feet. The present invention may include four substantially horizontal positioned concentric rings that may be constructed of two (2) inch polyethylene pipe. The first ring may be positioned three (3) inches from top of the support leg. The first ring is secured inside each support leg with an INNER LOCK SYSTEM™. The second ring may be positioned twenty-two (22) inches from the top of the support leg. The third ring may be positioned thirty-one (31) inches from the top of the support leg. The forth ring may be positioned forty (40) inches from the top of the support leg. The forth ring may be secured inside each support leg with the INNER LOCK SYSTEM™. The top of each support leg may be capped using heat fusion butt joint technology with a three (3) inch polyethylene pipe cap. The dimensions of the present invention may be adjusted to accommodate the overall comfortable feeding height of the animals intended.

Described and illustrated herein is a portable animal feeding device. While particular embodiments of the invention have been described, it is not intended that the invention be limited thereto, as it is intended that the invention be as broad in scope as the art will allow and that the specification be read likewise. It will therefore be appreciated by those skilled in the art that certain modifications could be made to the provided invention without deviating from its spirit and scope as so claimed.

What is claimed is:

1. A portable animal feed device comprising:
a top opening and a bottom opening;
at least four tubular concentric circles of substantially equal diameter;
at least four tubular support members substantially parallel to each other; and
wherein each of the four tubular concentric circles intersect each of the four tubular support members at a predetermined location along the support members vertical axis.

2. The device of claim 1 wherein, each of the said four tubular concentric circles are comprised of four substantially equal sub-members.

3. The structure of claim 1 wherein, the tubular support members are constructed of polyethylene with a three inch diameter, wherein each tubular support member is substantially forty-six inches in height.

4. The structure of claim 1 wherein, the animal feeding device had an internal diameter of substantially seven and one-half feet.

5. The structure of claim 1 wherein, the tubular concentric rings that are constructed of two (2) inch polyethylene pipe.

6. The structure of claim 1 wherein, the first tubular concentric ring is positioned three inches from top of the tubular support members

7. The structure of claim 1 wherein the second tubular concentric ring is positioned twenty-two inches from the top of the tubular support members.

8. The structure of claim 1 wherein the third tubular concentric ring is positioned thirty-one inches from the top of the tubular support members.

8. The structure of claim 1 wherein the third tubular concentric ring is positioned forty inches from the top of the tubular support members.

9. The structure of claim 1 wherein the top of each support leg is capped using heat fusion butt joint technology with a three inch polyethylene pipe cap.
